(19) United States
(12) Patent Application Publication
(10) Pub. No.: US 2016/0329130 A1
(43) Pub. Date: Nov. 10, 2016

(54) FLAT COAXIAL CABLE

(71) Applicant: WILSON ELECTRONICS, LLC, St. George, UT (US)

(72) Inventors: JOHN EVANS, St. George, UT (US); CHRISTOPHER K. ASHWORTH, St. George, UT (US)

(21) Appl. No.: 15/150,356

(22) Filed: May 9, 2016

Related U.S. Application Data
(60) Provisional application No. 62/158,107, filed on May 7, 2015.

(51) Int. Cl. H01B 11/18; H01R 13/648; H01B 13/016; H01R 43/02; H01B 7/08; H01R 43/20; H01R 13/646

(52) U.S. Cl. CPC H01B 11/1878; H01R 43/20; H01R 13/648; H01R 13/646; H01R 43/02; H01B 7/08; H01B 11/1808; H01B 13/0162

(57) ABSTRACT

A flat coaxial cable is disclosed. The flat coaxial cable can comprise a first ground layer; a second ground layer; a strip-line positioned between the first ground layer and the second ground layer; and a dielectric material positioned between the first ground layer and the second ground layer and surrounding the strip-line to insulate the strip-line from the first ground layer and the second ground layer. The flat coaxial cable can be resistant to a change in the general geometry of a body of the coaxial cable with the application of a perpendicular force to the body.

### RELATED APPLICATIONS

This application claims the benefit of and hereby incorporates by reference U.S. Provisional Patent Application Ser. No. 62/158,107 filed May 7, 2015.

### BACKGROUND

Coaxial cables are often used to carry radio frequency signals. The ability of coaxial cables to carry the radio frequency signals is dependent on the construction of the cables. The dimensions and relative placement of a center conductor, ground, and dielectric layers are typically selected to provide a desired electrical impedance for a selected frequency or frequency range. Round coaxial cables are often used to minimize construction cost and allow consistent dimensions along the coaxial cable.

However, the use of round coaxial cables in areas of relatively high bend radius and/or relatively high compression between surfaces can cause changes to the relative dimensions of the cables, thereby affecting the electrical properties of the cable and potentially diminishing the quality and/or power of the radio frequency signal.

### BRIEF DESCRIPTION OF THE DRAWINGS

Example embodiments will be described and explained with additional specificity and detail through the use of the accompanying drawings in which:

FIG. 1 illustrates an example flat cable in accordance with an example;

FIG. 2 illustrates a cross-section of an example flat cable in accordance with an example;

FIG. 3A illustrates a perspective view of a portion of an end of an example flat cable in accordance with an example;

FIG. 3B illustrates a cross-section of the portion of the end of the example flat cable of FIG. 3A coupled to a coupler in accordance with an example;

FIG. 4a illustrates a top view of an example flat cable including connector sleeves in accordance with an example; and

FIG. 4b illustrates a side view of the example flat cable of FIG. 4a in accordance with an example.

### DESCRIPTION OF EMBODIMENTS

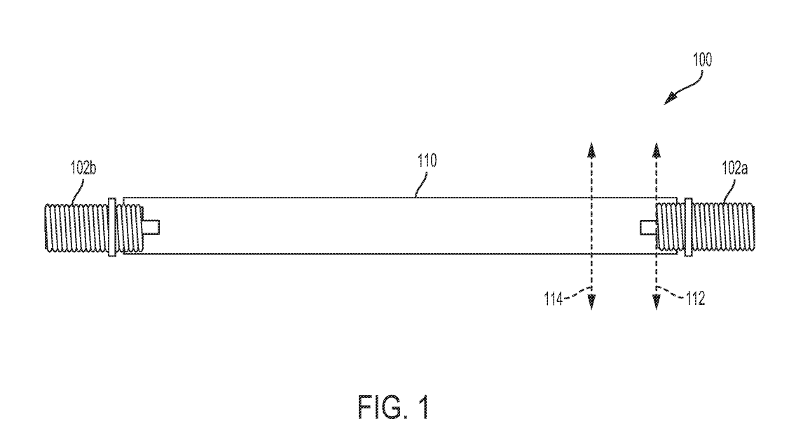

FIG. 1 illustrates an example flat cable 100, arranged in accordance with at least some embodiments described in this disclosure. The cable 100 may include a body 110 with a first coupler 102a coupled to a first end of the body 110 and a second coupler 102b coupled to a second end of the body 110.

The first coupler 102a may be a coaxial coupler or some other type of coupler. The second coupler 102b may be the same type of coupler as the first coupler 102a or a different type of coupler. Examples of couplers include a type F male or female connector, a Bayonet Neill-Concelman (BNC) type connector, an Ultra High Frequency (UHF) connector, a Sub-Miniature version A, B, or C (SMA, SMB, SMC), connector, or another type of radio frequency connector that is configured to operate at a desired impedance.

In some embodiments, the body 110 may be configured to carry electrical signals from the first coupler 102a to the second coupler 102b. In some embodiments, the body 110 may be configured such that it may carry electrical signals that have been carried by a coaxial cable. For example, the first coupler 102a and the second coupler 102b may be coupled to first and second coaxial cables. The body 110 may be configured to carry a signal from the first coaxial cable to the second coaxial cable without undue attenuation or distortion of the signal, such that the signal passes through the body 110 with similar distortion and loss as from passing through a coaxial cable. For example, in some embodiments, the impedance of the body 110 may be similar to an attached coaxial cable, such as 50 or 75 ohms.

In some embodiments, a length of the body 110 between the first coupler 102a and the second coupler 102b may vary and may depend on an intended use of the cable 100. For example, the length of the body 110 may be 1, 3, 6, 9, 12, 24 or 48 inches. Alternately or additionally, the length of the body 110 may be 1, 2, 5, 10, 20, 50, 100, or more feet.

In some embodiments, the body 110 may include an approximately square or rectangular cross-sectional shape. In these and other embodiments, the body 110 may include a strip-line of sufficient width and dimensions such that general strip-line electromagnetic field principles apply to the body 110. In these and other embodiments, the body 110 may be formed using materials for printed circuit boards. In particular, the body 110 may be formed using materials for flexible printed circuit boards. Alternatively, a polyimide film, such as Kapton, may be used to form selected layers of the body. In some embodiments, the body 110 may be constructed using material such that a general geometry of the body 110 does not substantially change with the application of a perpendicular force to the body 110. Modifications may be made to the cable 100 without departing from the scope of the present disclosure.

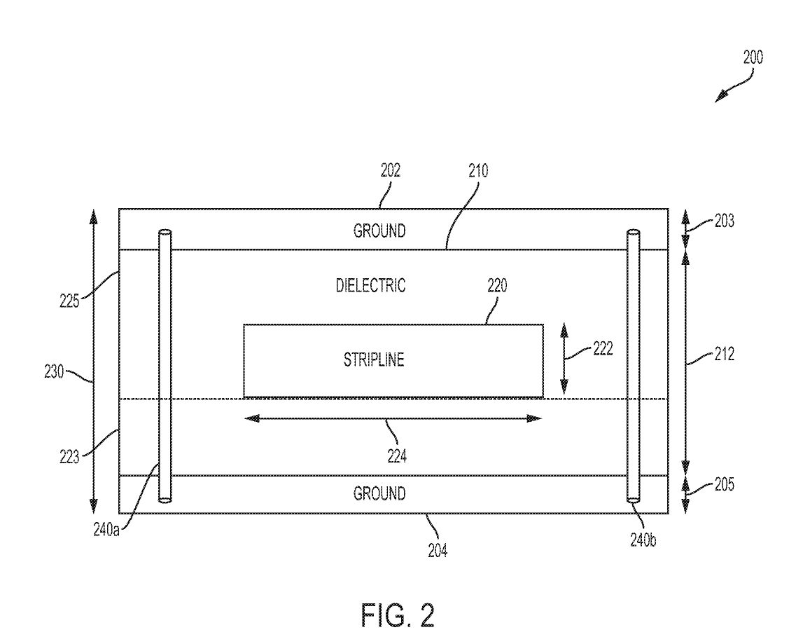

FIG. 2 illustrates a cross-section of an example flat cable 200, arranged in accordance with at least some embodiments described in this disclosure. The cable 200 may be analogous to the cable 100 of FIG. 1. In some embodiments, the cross-section may be a cross section of the cable 200 taken in a position similar to the line 114 of FIG. 1. In these and other embodiments, the cross-section may be in a plane perpendicular to a direction of travel of the signal carried by the cable 200. Thus, as illustrated a signal carried by the cable 200 would traverse in a direction perpendicular to the surface of FIG. 2, which is into, out of, or both into and out of FIG. 2.

The cable 200 includes a first ground layer 202, a second ground layer 204, a dielectric material 210, and a strip-line 220. The first ground layer 202 and the second ground layer 204 may be outer surfaces of two of the sides of the cable 200, such that the dielectric material 210 and the strip-line 220 are positioned between the first and second ground layers 202 and 204.

In some embodiments, the ground layer 204 can be substantially flat. The dielectric material 210 can also be formed of layers. For example, a first dielectric layer 223 may be located below the strip-line. A second dielectric layer 225 may be located above the strip-line. Each dielectric layer can be substantially flat and positioned in parallel to the ground layer 204, as shown in FIG. 2. The strip-line 220 can be parallel to the ground layer 204 and the layers of the dielectric material 210. The top ground layer 202 can be substantially flat and parallel to the dielectric layers, strip-line 222, and ground layer 210. The top ground layer 202, dielectric layers 223 and 225, strip-line 222, and bottom ground layer 204 can form a vertical sandwich that comprises the cable 200.

In some embodiments, the ground layers 202 and 204 can be comprised of a solid conductor. Alternatively, the ground layers 202 and/or 204 can be configured as a braided wire, or wire thread mesh, comprised of a plurality of thinner wires to form a ground layer. The first ground layer 202 may have a thickness 203 and the second ground layer 204 may have a thickness 205. The thickness 203 and the thickness 205 may be similar or different. In some embodiments, the thickness 203 and the thickness 205 may range between 10 micrometers (μm) and 100 μm each. In some embodiments, the thickness 203 and the thickness 205 may range between 20 and 45 μm each. A thickness of each individual strand in the braided wire or wire thread mesh may be less than a thickness of a solid conductor. The reduced thickness of each strand can allow the cable 200 to have a shorter bend radius without damaging or kinking the ground layers 202, 204 since the thinner conductors forming the braided wire or wire thread can be bent at a shorter bend radius without significantly changing the impedance or other radio frequency characteristics of the cable 200 relative to a thicker, solid conductor ground layer. The type of braided wire or wire thread mesh can depend on the frequency of the signal traveling over the cable 200. The braided wire or wire thread mesh can be configured to have through holes that are substantially smaller than a wavelength of the signal. For example, less than ½, ¼, ⅛, or 1/16^{th} of the wavelength of the signal traveling over the cable.

The first ground layer 202 may be formed of a solid flexible conductor. Alternately or additionally, the first ground layer 202 may be formed from a hatched, stranded, or other type of flexible conductor. The conductor types used in the first ground layer 202 may be copper, Kapton, gold, silver, or aluminum, among other types of conductors. The second ground layer 204 may be formed in a manner analogous to the first ground layer 202 with a similar material or the second ground layer 204 may be different from the first ground layer 202.

In some embodiments, the strip-line 220 may be configured to be approximately centered between the first and second ground layers 202 and 204 and approximately centered between lateral edges of the first and second ground layers 202 and 204. Alternately or additionally, the strip-line 220 may be configured to be offset from the center between the first and second ground layers 202 and 204 and/or offset from the center between lateral edges of the first and second ground layers 202 and 204. The strip-line 220 may include a conductive material and may be configured to carry a signal through the cable 200. For example, the conductive material may be copper, Kapton, silver, gold, or aluminum, among other types of conductive material. In one example embodiment, a conductive tape, such as 3M® 1170, 1181, 1182, 1183, 1190, 1194, or 1245 may be used.

The strip-line 220 may have a thickness 222 and a width 224. In some embodiments, the width 224 may be at least twice as large as the thickness 222. In some embodiments, the width 224 may be such that strip-line electromagnetic field theory may be applied to understand the electromagnetic effect to a signal traversing the strip-line 220. In some embodiments, the thickness 222 may be between 35 and 150 μm. In some embodiments, the thickness 222 may range between 60 and 90 μm.

In some embodiments, the strip-line 220 may be sized and the conductive material for the strip-line 220 may be selected such that the strip-line 220 provides a particular impedance, such as 50 or 75 ohms. In these and other embodiments, the particular impedance may be selected and the strip-line 220 may be sized and the conductive material selected based on a system within which the cable 200 may be configured to operate. For example, the impedance of the strip-line 220 may be designed to substantially match an impedance of the system within which the cable 200 is configured to operate.

In some embodiments, the strip-line 220 can be configured to carry a direct current (DC) signal and an alternating current (AC) signal. The DC signal may be used to provide power. The AC signal may be used to carry information.

The strip-line 220 can be formed of a single conductor. The single conductor may be a wire. Alternatively, the strip line can be printed on a surface, such as a surface of a dielectric layer.

The dielectric material 210 may surround the strip-line 220 to insulate the strip-line 220 from the first and second ground layers 202 and 204. In these and other embodiments, the dielectric material 210 may contact the first and second ground layers 202 and 204 and may extend between the lateral edges of the first and second ground layers 202 and 204. The dielectric may be formed of any dielectric material or combination of dielectric materials, including silicon, silicon-oxides, Kapton, and polymers, among other dielectrics. The dielectric material 210 may include a thickness 212 between the first and second ground layers 202 and 204. In some embodiments, multiple layers of dielectric material may be stacked vertically to provide a desired impedance, such as 50 ohms or 75 ohms or another desired impedance. The thickness 212 of each dielectric layer 223, 225 may range between 150 and 1500 μm. In some embodiments, the thickness 212 of each dielectric layer 223, 225 may range between 300 and 600 μm. In some embodiments, the thickness 212 may be configured such that a minimum distance between the strip-line 220 and either of the first and second ground layers 202 and 204 is greater or less than the thickness 222 of the strip-line 220.

In some embodiments, a thickness 230 of the cable 200 may range between 190 μm and 3000 μm. In some embodiments, the thickness 230 of the cable 200 may range between 350 and 700 μm.

The cable 200 may also be configured to be flexible. In these and other embodiments, each of the first ground layer 202, the second ground layer 204, the dielectric material 210, the strip-line 220 may be formed of materials and formed in a particular shape and manner such that each of the first ground layer 202, the second ground layer 204, the dielectric material 210, the strip-line 220 may have a stiffness that is within a range of stiffness that would allow a typical person to bend the cable 200 with their hands without using any tools. Furthermore, the combination and arrangement of the first ground layer 202, the second ground layer 204, the dielectric material 210, and the strip-line 220 may be such that the stiffness of the cable 200 is within a range of stiffness that would allow a typical person to bend the cable 200 with their hands without using any tools. In one example, the cable 200 can be configured to have a bend radius of 2 mm or less. In another embodiment, the bend radius may be 10 mm, 5 mm, 4 mm, 3 mm, or another desired bend radius, depending on the materials selected for the cable 200.

The cable 200 can be assembled using an adhesive material to join the first ground layer 202, the second ground layer 204, the dielectric material 210, and the strip-line 220. The adhesive can be selected based on the components used to form the various materials. The adhesive can be selected to have good radio frequency properties to minimize radio frequency losses within the cable 200.

The thickness 230 and flexibility of the cable 200 may allow the cable 200 to be placed between a window and a window sash such that when the window is closed there is a minimum seal gap or minimum change in the ability of the window to close properly. The cable can be configured such that the perpendicular forces and the bending applied to the body of the cable, when the cable is placed between the window and the window sash, will not substantially change a geometry of the body 110 of the cable. Minimizing the change in the geometry of the body when force is applied and bending occurs enables the cable 200 to have substantially the same impedance and radio frequency characteristics.

If the dimensions of selected layers change, such as the dimensions of the dielectric material 210 changing relative to the dimensions of the strip-line 220, it can cause changes in impedance in the cable 200, which can result in a significant impedance loss. A typical round coaxial cable may have its dielectric layer crushed (i.e. reduced in width relative to the center conductor) when the coaxial cable is closed in a window or other type of enclosure, thereby resulting in a significant change in impedance in the coaxial cable. The substantially flat cable 200 can be enclosed in a window with minimal changes in the geometry of the body, thereby reducing any change in impedance when the window is closed, locked, and/or sealed around the cable 200.

Thus, the cable 200 may be used with any communication system that includes elements outside and inside of a window. For example, the cable 200 may be used with a signal booster system. An example signal booster system is described in U.S. patent application Ser. No. 14/166,246, filed on Jan. 28, 2014, which is incorporated herein by reference in its entirety. The cable 200 can be placed between a window and a window sash, with the window closed and sealed, and substantially maintain the same impedance and radio frequency characteristics, thereby enabling information and electrical power to be carried across the cable with minimal loss in signal quality and power.

For example, in some embodiments, a change in insertion loss can occur for a flat coaxial cable, such as cable 200, that is compressed and/or bent by placing the cable between two surfaces, such as between a window and a window sash, with the window closed or sealed or locked. The insertion loss can be measured at a desired frequency for the flat coaxial cable. In some examples, the insertion loss can be measured over a bandwidth of 600 Megahertz (MHz) to 2700 MHz. In other embodiments, the insertion loss can be measured at 500 MHz to 4000 MHz. In one example, insertion loss and return loss can be measured at a center frequency of 2000 MHz over a selected bandwidth.

The change in insertion loss for the cable 200, due to bending or compression when the cable is placed between two surfaces, can be from less than 0.1 dB to 1 dB, relative to an insertion loss of the cable 200 when the cable 200 is not compressed or bent by two surfaces, such as the closed window or other type of a threshold.

The change in impedance or other radio frequency characteristics due to bending and compression can also be measured by a change in return loss. The cable 200 may have a return loss of greater than 10 dB when the cable is not compressed or bent. When the cable is compressed or bent between surfaces, such as the window and the window sash, the return loss may decrease from less than 0.1 dB to 2 db.

While a window has been provided as an example of two surfaces in which the cable may be compressed and/or bent, this example is not intended to be limiting. The cable may also be used in other areas where pressure and bending may occur, such as a door or located between different structures that may cause bending and/or compression. The construction of the flat cable from relatively flat components, such as the ground layers 202, 204, the dielectric layer 210, and the strip-line 220 can enable significantly reduced changes in radio frequency characteristics of the cable due to changes in the geometry of the cable caused by compression and bending. The flat components can also be selected as having a resistance to crushing by compression or bending.

The signal booster system in U.S. patent application Ser. No. 14/166,246 includes a signal booster with a first antenna and a second antenna. In these and other embodiments, the cable 200 may be used to couple the signal booster to either the first antenna or the second antenna. In some embodiments, the first antenna and the signal booster may be placed inside of a building and the second antenna may be placed outside of the building to allow the second antenna to better communicate with an access point, such as a base station or eNodeB. In these and other embodiments, the cable 200 may be run across a window sash from inside to outside the building to communicatively couple the second antenna outside of the building to the signal booster inside the building. Within the flexibility and the minimal thickness of the cable 200, the window may still be closed and substantially sealed even with the cable 200 located between the window and the window sash.

In some embodiments, the cable 200 may include a first ground via 240a and a second ground via 240b. The first ground via 240a may extend between the first ground layer 202 and the second ground layer 204 to electrically couple the first ground layer 202 and the second ground layer 204. The second ground via 240b may also extend between the first ground layer 202 and the second ground layer 204 to electrically couple the first ground layer 202 and the second ground layer 204. In some embodiments, the cable 200 may include multiple ground vias spaced along the length of the cable 200. In some embodiments, the ground vias may be equally or unequally spaced. Alternately or additionally, the ground vias may be spaced equal on both sides of the cable 200, may follow a staggered pattern, or may be randomly placed.

Modifications may be made to the cable 200 without departing from the scope of the present disclosure. For example, in some embodiments, the cable 200 may not include the first ground via 240a, the second ground via 240b, or either of the first ground via 240a and the second ground via 240b.

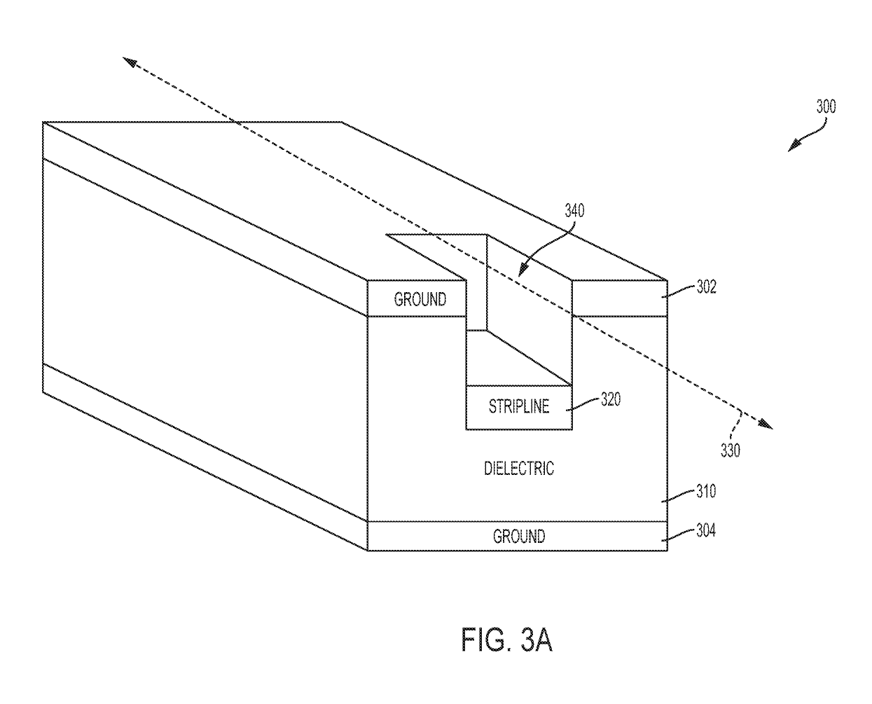

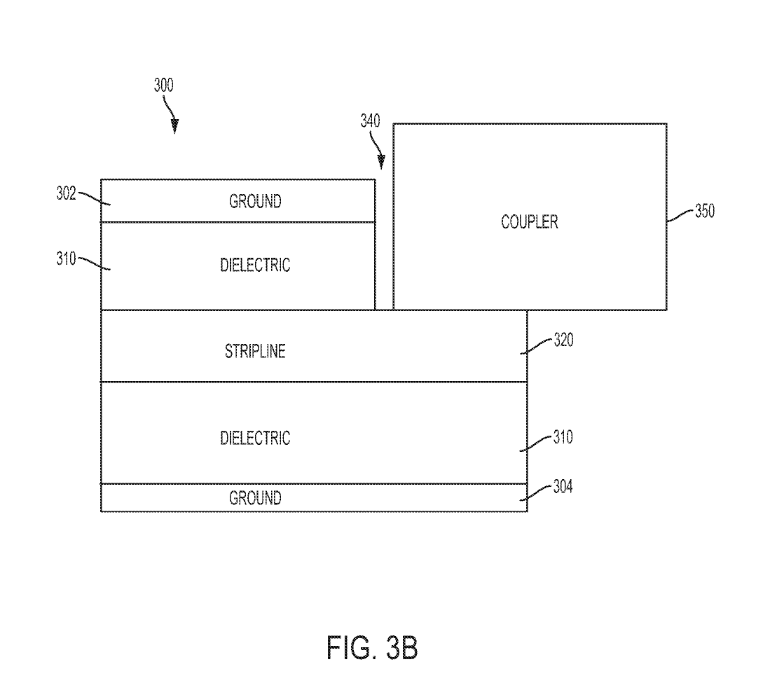

FIG. 3A illustrates a perspective view of a portion of an end of the example flat cable 300, arranged in accordance with at least some embodiments described in this disclosure. The cable 300 may be analogous to the cable 100 of FIG. 1. In some embodiments, a near view side of the portion of the end of the cable 300 may be in a position similar to the line 112 of FIG. 1.

The cable 300 may include a first ground layer 302, a second ground layer 304, a dielectric material 310, and a strip-line 320. The first ground layer 302, the second ground layer 304, the dielectric material 310, and the strip-line 320 may be analogous to the first ground layer 202, the second ground layer 204, the dielectric material 210, and the strip-line 220 of FIG. 2.

As illustrated in FIG. 3, a portion of the first ground layer 302 and the dielectric material 310 may be removed to expose a portion of the strip-line 320. The removed portion of the first ground layer 302 and the dielectric material 310 may form an opening 340 in the cable 300. The opening 340 may have a rectangular, oval, circular, or square cross-sectional shape, or some other cross-sectional shape. In some embodiments, the opening 340 may include one or more sides that are perpendicular to a top or bottom of the cable 300. Alternately or additionally, the opening 340 may include one or more sides that are sloped with respect to the top or bottom of the cable 300.

In some embodiments, a portion of a connector may be placed in the opening 340 to allow the portion of the connector to be in direct contact with and electrically coupled to the strip-line 320. In these and other embodiments, the opening 340 may be sized and shaped according to the portion of the connector that is placed in the opening 340. For example, a signal carrying conductor of the first coupler 102a of FIG. 1 may be placed in the opening 340 and directly coupled to the strip-line 320. In these and other embodiments, a ground conductor of the first coupler 102a may be coupled to the first ground layer 302 and the second ground layer 304.

A length of the cable 300 can run along line 330. The thickness of the cable 230 (FIG. 2) can run in a direction perpendicular to the length.

In these and other embodiments, directly coupling the signal carrying conductor of a coupler may reduce impedance discontinuities or changes between the strip-line 320 and the signal carrying conductor. Reducing the impedance discontinuities or changes may reduce signal degradation of a signal that passes along the cable 300.

FIG. 3B illustrates a cross-section of the portion of the end of the cable 300 coupled to a coupler 350, arranged in accordance with at least some embodiments described in this disclosure. In some embodiments, the cross-section may be a cross section of the cable 300 taken along the line 330 of FIG. 3A. As illustrated in FIG. 3B, the coupler 350 is located in the opening 340 and is directly coupled to the strip-line 320. In some embodiments, the coupler 350 as illustrated may be a signal carrying conductor of the coupler 350. In some embodiments, the coupler 350 may be a coaxial connector. In some embodiments, the cable may have a width that is approximately the same as the coupler 350. In some embodiments, the width of the cable can be from 3000 μm to 25,400 μm. In these and other embodiments, the portion of the coaxial connector illustrated in FIG. 3B may be the inner conductor of the coaxial connector. Modifications may be made to the cable 300 without departing from the scope of the present disclosure.

In some embodiments, the cable 300 can be assembled by preparing a section of dielectric material 310 having a desired length, and a section of ground layer 302 having a similar length of the dielectric material. The two lengths can be adhesively joined to form a top section. A second adhesively joined section can be formed with a section of ground layer 304 and dielectric material 310 in a similar manner to form a bottom section. A thickness of the dielectric material 310 can be selected to provide a desired impedance for the cable 300.

The opening 340 can be formed in each end of one of the top section or the bottom section. The strip-line 320 can be placed along the length of the top section or the bottom section, at approximately a center of the opening 340, and the bottom section and top section can be adhesively joined. A coupler 350, such as one of the couplers previously discussed, can be soldered or otherwise electrically coupled to one or more of the ground layer 302, ground layer 304, and the strip-line 320. The ground layers 302, 304 can be electrically coupled to an outer body portion of the coupler 350, and a center conductor of the coupler 350 can be electrically coupled to the strip-line 320 to form the cable 300. The cable 300 can then be coated with an insulating material, such as a plastic molding, to protect the cable 300 from environmental damage.

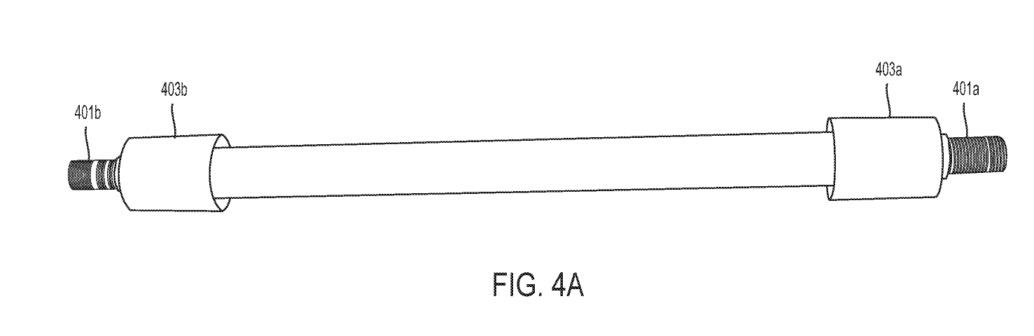

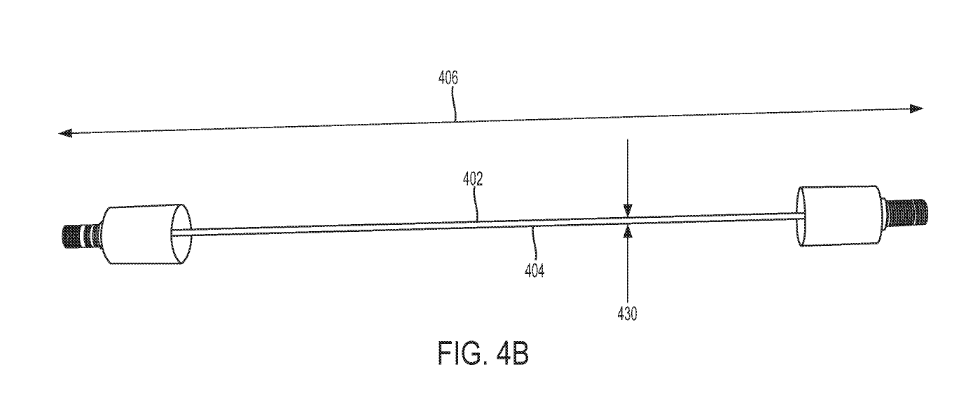

FIG. 4a provides an example illustration of a top view of an assembled flat coaxial cable 400. The flat coaxial cable 400 includes two radio frequency connectors 401a, 401b that are electrically connected to the strip-line and first and second conductive layers. The connectors can include connector sleeves 403a and 403b used to provide environmental protection of the ends of the flat coaxial cable 400. The connector sleeves may be formed of silicon, or another desired material, to provide environmental and stress protections for the ends of the flat coaxial cable 400. The flat coaxial cable 400 can also include a coating or covering for an outside of the coaxial cable to provide environmental and electrical protection to the layers of the cable. Alternatively, no outer coating may be applied to maximize the thinness, and flexibility of the flat coaxial cable 400.

FIG. 4b provides an example illustration of a side view of an assembled flat coaxial cable 400. The thickness 430 of the flat coaxial cable 400 is illustrated. A top portion 402 of the flat coaxial cable 400 may comprise the ground 302 (FIG. 3a). A bottom portion 404 of the flat coaxial cable may comprise the ground 304 (FIG. 3b). Alternatively, a coating may cover the grounds 302, 304, as previously discussed. The dielectric layers 223 and 225 and strip-line 222 (FIG. 2) can be located between the top layer 402 and the bottom layer 404, with the strip-line 222 substantially centered between the top layer and the bottom layer, as illustrated in FIG. 2. A length of the cable 406 can be 2, 4, 8, 12, 24, or 48 inches, as previously discussed. Longer cables may also be formed. While the length illustrated in the example of FIG. 4b is shown to include the RF connectors, this is not intended to be limiting. The length may be only the flat coaxial cable itself, not including the connectors.

In another embodiment, a method 500 of forming a flat coaxial cable is disclosed, as illustrated in the flow chart of FIG. 5. The method comprises adhesively joining a first ground layer and a first dielectric film to form a top section, as shown in 510. A second ground layer can be adhesively joined with a second dielectric film to form a bottom section, as shown in 520. A strip-line can be provided between the top section and the bottom section, as shown in 530. The top section and the bottom section can be adhesively joined to surround the strip-line to form the flat coaxial cable, as shown in 540.

The method 500 can further comprise electrically coupling a radio frequency connector to a first end and a second end of the first ground layer, the second ground layer, and the strip-line. One of the top section and the bottom section can be notched (i.e. cut) to form an opening to enable a signal carrying conductor of the radio frequency connector to be electrically coupled to the strip-line. A ground conductor of the radio frequency connector can be electrically connected to the first ground layer and the second ground layer. A plurality of vias can be electrically connected, along a length of the cable, between the first ground layer and the second ground layer.

The method 500 can further comprise forming the first ground layer or the second ground layer from one of a solid conductor and a mesh conductor, wherein the first ground layer and the second ground layer have a thickness of between 10 micrometers (μm) and 100 μm. The first dielectric film and the second dielectric film can be formed from a Kapton film, with a thickness of between 150 μm and 900 μm. In another embodiment, the film can have a thickness between 150 μm and approximately 1500 μm. Accordingly, a cable formed using two stacked sections of the dielectric film can have a maximum thickness of approximately 3000 μm. Alternatively, multiple thinner layers of the dielectric film, such as Kapton, can be used to achieve a desired thickness of the cable. The dimensions of the strip-line can be adjusted based on the dimensions of the dielectric film, or vice-versa, to achieve a desired impedance of the cable, as previously discussed. In some embodiments, the strip line can be printed on one of the first dielectric film or the second dielectric film. Alternatively, a single conductor can be placed near a center of the dielectric layer of the cable (i.e. between two layers or two stacks of dielectric film).

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that various changes, substitutions, and alterations could be made hereto without departing from the spirit and scope of the present disclosure.

What is claimed is:

1. A flat coaxial cable, comprising:
a first ground layer having a thickness from 10 micrometers (μm) to 100 μm;
a second ground layer having a thickness from 10 μm to 100 μm;
a strip-line positioned vertically between the first ground layer and the second ground layer, and having a thickness from 35 μm to 150 μm; and
a dielectric material, having a thickness from 150 μm to 1500 μm, wherein the dielectric material is positioned vertically between the first ground layer and the second ground layer and surrounding the strip-line to insulate the strip-line from the first ground layer and the second ground layer to form the flat coaxial cable with a thickness, measured from a top of the first ground layer to a bottom of the second ground layer, of less than or equal to 3000 μm.

2. The flat coaxial cable of claim 1, wherein the coaxial cable has a bend radius of less than or equal to 5 mm or a bend radius of less than or equal to 2 mm.

3. The flat coaxial cable of claim 1, wherein the coaxial cable has a thickness of less than or equal to 1500 μm.

4. The flat coaxial cable of claim 1, wherein the strip-line is a conductor comprised of a single wire or a printed conductor on the dielectric material.

5. The flat coaxial cable of claim 1, wherein one or more of the first ground layer and the second ground layer are formed of a metal mesh.

6. The flat coaxial cable of claim 1, wherein the dielectric material is a polyimide film.

7. The flat coaxial cable of claim 1, wherein the dielectric material is comprised of a plurality of layers of a polyimide film.

8. The flat coaxial cable of claim 1, further comprising a radio frequency coupler electrically coupled to the first ground layer, the second ground layer, and the strip line at each end of the flat coaxial cable.

9. The flat coaxial cable of claim 1, wherein the flat coaxial cable has a length from 2 inches to 48 inches.

10. The flat coaxial cable of claim 1, wherein a change in insertion loss for the flat coaxial cable, when compressed or bent between two surfaces, is less than 1 dB at a frequency of 2 megahertz, relative to an insertion loss of the flat coaxial cable when the flat coaxial cable is not compressed or bent by the two surfaces.

11. The flat coaxial cable of claim 10, wherein the two surfaces are a window and a window sash, wherein the flat coaxial cable is compressed when placed between the window and the window sash and the window is closed or sealed or locked.

12. The flat coaxial cable of claim 10, wherein the change in insertion loss for the flat coaxial cable, when compressed or bent between the two surfaces, is less than 0.2 dB at a frequency of 2 Megahertz, relative to in insertion loss at the frequency of 2 Megahertz when the flat coaxial cable is not compressed or bent between the two surfaces.

13. A method of forming a flat coaxial cable, comprising:
adhesively joining a first ground layer and a first dielectric film to form a top section;
adhesively joining a second ground layer and a second dielectric film to form a bottom section;
providing a strip-line between the top section and the bottom section; and
adhesively joining the top section and the bottom section to surround the strip-line to form the flat coaxial cable.

14. The method of claim 13, further comprising electrically coupling a radio frequency connector to a first end and a second end of the first ground layer, the second ground layer, and the strip-line.

15. The method of claim 14, further comprising notching one of the top section and the bottom section to form an opening to enable a signal carrying conductor of the radio frequency connector to be electrically coupled to the strip-line.

16. The method of claim 14, further comprising connecting a ground conductor of the radio frequency connector to the first ground layer and the second ground layer.

17. The method of claim 13, further comprising electrically connecting a plurality of vias along a length of the cable between the first ground layer and the second ground layer.

18. The method of claim 13, further comprising forming the first ground layer or the second ground layer from one of a solid conductor and a mesh conductor, wherein the first ground layer and the second ground layer have a thickness of between 10 micrometers (μm) and 100 μm.

19. The method of claim 13, further comprising forming the first dielectric film and the second dielectric film from a Kapton film, with a thickness of between 150 μm and 900 μm.

20. The method of claim 13, further comprising printing the strip line on one of the first dielectric film or the second dielectric film.

21. A flat cable, comprising:
a first ground layer;
a second ground layer;
a strip-line vertically positioned between the first ground layer and the second ground layer; and
a dielectric material vertically positioned between the first ground layer and the second ground layer and surrounding the strip-line to insulate the strip-line from the first ground layer and the second ground layer.

22. The flat cable of claim 21, wherein the first ground layer, the second ground layer, the strip-line, and the dielectric material are arranged in a stacked formation.

23. The flat cable of claim 21, wherein the flat cable is flexible such that the flat cable includes a stiffness that is within a range of stiffness that would allow a typical person to bend the flat cable with their hands without using any tools.

24. The flat cable of claim 21, further comprising an opening at a first end of the flexible cable through a portion of the first ground layer and the portion of the dielectric material that exposes the strip-line.

25. The flat cable of claim 24, further comprising a coupler, a signal carrying conductor of the coupler positioned in the opening and directly coupled to the strip-line.
